(19) United States
(12) Patent Application Publication
(10) Pub. No.: US 2011/0202338 A1
(43) Pub. Date: Aug. 18, 2011

(54) SYSTEM AND METHOD FOR RECOGNITION OF ALPHANUMERIC PATTERNS INCLUDING LICENSE PLATE NUMBERS

(76) Inventor: Philip INGHELBRECHT, San Francisco, CA (US)

(21) Appl. No.: 13/026,993

(22) Filed: Feb. 14, 2011

Related U.S. Application Data
(60) Provisional application No. 61/305,790, filed on Feb. 18, 2010.

(51) Int. Cl. G10L 15/00

(52) U.S. Cl. 704/231; 704/E15.001

(57) ABSTRACT

Voice recognition technology is combined with external information sources and/or contextual information to enhance the quality of voice recognition results specifically for the use case of reading out or speaking an alphanumeric identifier. The alphanumeric identifier may be associated with a good, service, person, account, or other entity. For example, the identifier may be a vehicle license plate number.

### RELATED APPLICATIONS

The present application claims priority under 35 U.S.C. §119 to U.S. Provisional Patent Application 61/305,790, filed Feb. 18, 2010, which is hereby incorporated by reference in its entirety into the present application.

### FIELD OF THE INVENTION

The present disclosure relates generally to recognition of alphanumeric patterns. More particularly, the present disclosure relates to the recognition of spoken alphanumeric patterns.

### BACKGROUND OF THE INVENTION

A variety of systems, software applications and electronic devices could benefit from allowing a person to use speech or audio information to input an alphanumeric identifier. For example, vehicle license plate numbers are typically made up of a numeric or alphanumeric code, usually counting anywhere between 5 to 7 characters. Because they are a substantially unique identifier to a vehicle, and as such its registered owner, various constituencies use the license plate to quickly identify unique vehicles and/or their registered owners. In order to process the license plate, these constituencies typically use methods such as automated image recognition (e.g. assessing road toll charges over the Golden Gate Bridge) or manual input using a keyboard (e.g. a law enforcement officer using a patrol vehicle board computer). Automated speech recognition is rarely if ever used to input identifiers comprising alphanumeric characters.

This situation may be due to a variety of reasons such as: individual letters, like short words, contain a very limited amount of acoustic information thus leading to poor quality results from automated speech recognition; difficulty in telling spoken letters apart in running speech; a focus in automated speech recognition on delineating full words and/or phrases, not single phonemes; and current automated speech recognition technologies mostly pay attention to vowels.

Automated speech recognition technologies are particularly challenged in differentiating the sounds associated with single-syllable letters. One example is the “e-set” of letters that, when spoken, contain very similar “ee” sounds. These include “b,c,d,e,g,p,t,v,z”. Unlike the phonemes found in words and sentences, the phonemes that make up spoken alphanumeric identifiers have a near-random pattern, which means that an automated speech recognition engine is much more difficult for distinguishing these spoken phrases.

### SUMMARY

One or more aspects of this disclosure relate to a voice recognition solution for alphanumeric identifiers, such as but not limited to license plates. The approach described uniquely combines voice recognition technology with external information sources (e.g., license plate databases and/or other information sources) and/or contextual information (e.g., location-information and/or other contextual information) to vastly improve the quality of voice recognition results specifically for the use case of reading out or speaking an alphanumeric identifier.

A method for enhancing automated speech recognition accuracy when used to identify a unique vehicle license plate number by combining the analysis of license plate syntax with automated speech recognition technology. Vehicle license plate number syntax information, which can be used to determine expected alphanumerical combinations, may include contextual inputs such as geo-location data, information about the end-user, vehicle license plate number records and other automotive vehicle records, or other types of information. A number of parameters from this syntax are used to statistically rank the most plausible utterance of a license plate spoken by an end-user, and as such allow traditional voice recognition engines to successfully improve their ability to recognize spoken alphanumerical values that make up a vehicle license plate number sequence found in the complete set of vehicle license plate number records.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a method of recognizing an audible alphanumeric pattern associated with an identifier.

FIG. 2 illustrates a system configured to capture, segment, and/or recognize audible data including an alphanumeric pattern associated with an identifier.

### DETAILED DESCRIPTION

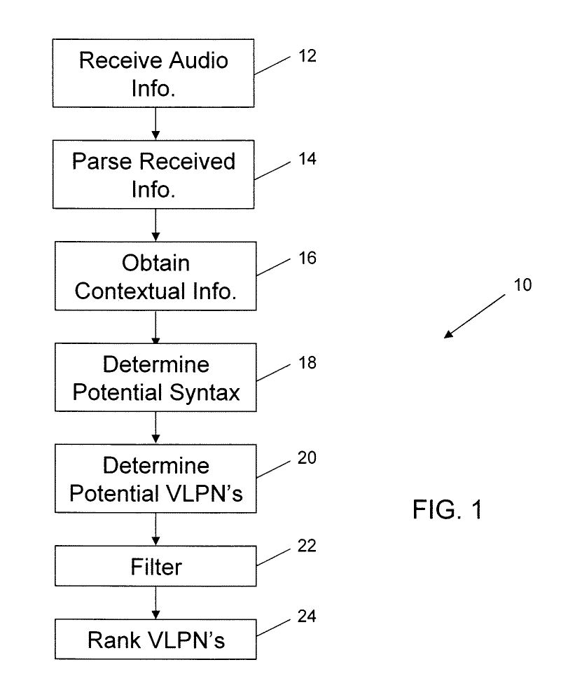

FIG. 1 illustrates a method 10 of recognizing an audible alphanumeric pattern associated with an identifier. The identifier may include an alphanumeric pattern used to identify a good, service, person, account, or other entity. An identifier may be unique to a specific entity (e.g., to a specific car), or may be used to identify a class of entities (e.g., cars of a particular make, model, year, and/or other classes). In the discussion below of method 10, implementations in which the identifier includes a vehicle license plate number associated with an individual vehicle license plate and/or vehicle. It will be appreciated that this is not intended to be limiting, as the principles discussed below with respect to the identification of vehicle license plates and/or vehicles may be extended to other identifiers. The operations of method 10 presented below are intended to be illustrative. In some implementations, method 10 may be accomplished with one or more additional operations not described, and/or without one or more of the operations discussed. Additionally, the order in which the operations of method 10 are illustrated in FIG. 1 and described below is not intended to be limiting.

In some embodiments, method 10 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 10 in response to instructions stored electronically on an electronic storage medium. The one or more processing devices may include one or more devices configured through hardware, firmware, and/or software to be specifically designed for execution of one or more of the operations of method 10.

At an operation 12, audio information may be received. The audio information may correspond to a vehicle license plate number. In some implementations, this audio information may be a capture of the sound of a user speaking a sequence of letters and numbers corresponding to a vehicle license plate number of a vehicle license plate.

At an operation 14, the received sound(s) can then be parsed and may be segmented into “high certainty” matches with individual alphanumeric characters (e.g. most numbers and many letters) and “low certainty” matches with individual alphanumeric characters (e.g. the “e-set” of letters such as b,c,d,e, etc).

At an operation 16, contextual information may be obtained. The contextual information may include one or more of a context of a vehicle associated with the vehicle license plate, a context of the user, a description of the vehicle associated with the vehicle license plate, and/or other contextual information. The context of the vehicle may include the location and/or surroundings of the vehicle. The context of the user may include the locations and/or surroundings of the vehicle.

At an operation 18, one or more potential licenses plate patterns are determined. A license plate pattern may refer to a sequence of characters in which certain spots in the sequence are determined to (or determined to be more likely to) have some characteristic. The characteristic may include, for example, being a number; being a letter, being a number above a threshold, below a threshold, or within a range; being a letter in some range, being a consonant letter, coming from a predetermined set of letters, and/or other characteristics. In some implementations, the user's location or other contextual factors may be utilized to determine a statistical likelihood of various license plates patterns for the specific context of the user. In some implementations, contextual information may be combined with descriptive data for license plate formations in a local area to assess the likely number range of unique letters/digits in the license plate. For example, if the user is located in Portland, Oreg., the license plate sequencing (pattern) used by the states of Oregon as well as bordering states such as Washington and California. For example, suppose that all Oregon license plates are 5 digits long and always start with 2 letters, that Washington license plates are 6 digits long and start with 3 letters and that California license plates are 6 digits long and are usually 1 digit follow by two letters and another digit and two letters. Other contextual factors that may be accounted for in determining likely license plate patterns are the population of registered drivers in each state or whether the user is currently on an interstate highway or a residential block. It will be noted that these factors are exemplary only and other factors may also be utilized to determine the statistical likelihood of various license plate patterns.

At an operation 20, a set of potential permutations of license plate numbers that may correspond to the received sound(s) may be determined. This determination may be based on the segmented characters (e.g., determined at operation 14) and the potential license plate patterns (e.g., 5 or 6 digits, etc.) (e.g., determined at operation 18) with associated statistical likelihood and the known sounds that are “low certainty” sounds combined with their likely “possibilities” (e.g. a letter from “e-set” could be any of the following b,c,d,e, etc).

At an operation 22, the determined set of potential vehicle license plate numbers may be individually matched against a nationwide database of license plate numbers to eliminate all variations for which no matching license plate currently exists. This may result in fewer potential vehicle license plate numbers.

At an operation 24, the remaining potential vehicle license plate numbers may be ranked. In some implementations, the contextual information may be used to rank the potential vehicle license plate numbers according to probability of correctness. The probability of correctness for the individual potential vehicle license plate numbers may reflect the assumption that drivers tend to drive their registered vehicles mostly in their home state and, if visiting from another state then probably it will be a closely proximate state (e.g. the less hours of drive time away the more likely it could be a specific state). Thus, the result of this operation may be a set of ranked, actually registered license plate numbers with (or without) an estimated probability of correctness (e.g. percentage) associated with each as a prediction of the individual potential vehicle license plate numbers being an accurate interpretation of the received sounds. In some implementations, different user experiences can then be used to enable the user to select the correct license plate number from the possible license plate numbers through a user interface. These include such variations as (a) presenting just one result but easily letting the user correct only the “low certainty” letters in the sequence using the next best estimates (b) presenting a list of the “most likely” choices (e.g. Top three) and letting the user select one (c) presenting a complete scrollable list of all possible sequences ranked by likelihood, and/or through other user interfaces. The user interface may be presented to the user via, for example, a client computing platform.

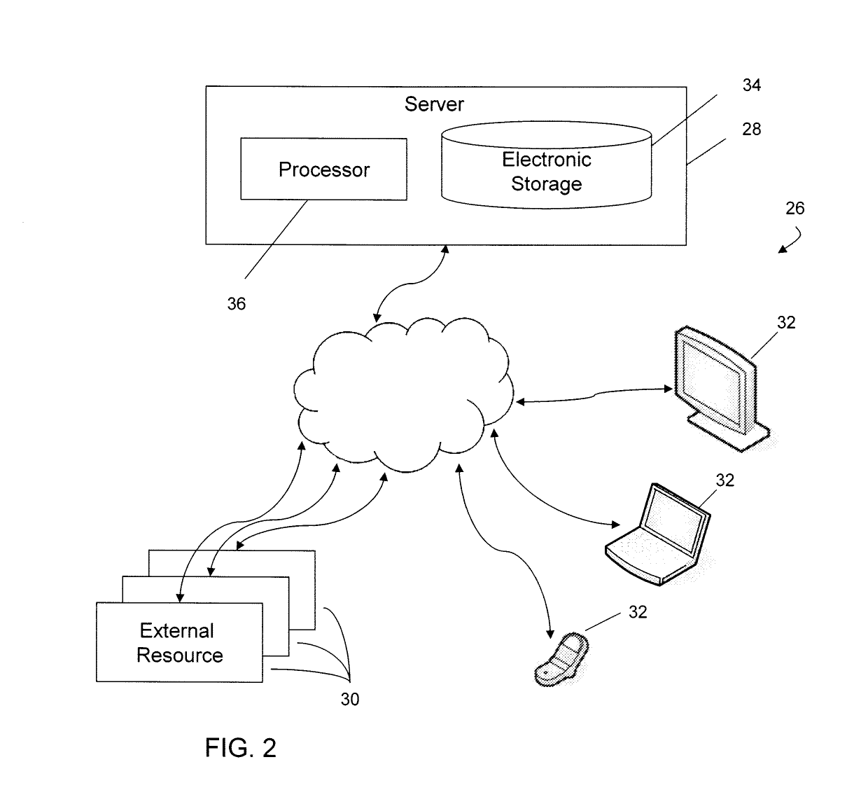

FIG. 2 depicts one or more implementations of a system 26 configured to capture, segment, and/or recognize audible data including an alphanumeric pattern associated with an identifier. The audible data may include spoken identifiers comprised of alphanumeric characters. The identifiers may be associated with a good, service, person, account, or other entity. Description herein of implementations in which the identifier is a vehicle license plate number associated with a vehicle license plate should not be viewed as limiting. The principles described herein are extendible to identifiers that include account identifiers, product identifiers, service identifiers, transaction identifiers, corporation identifiers, flight identifiers, confirmation identifiers, customer identifiers, and/or other identifiers. The system may include one or more servers 28, and/or other components. The system 26 may operate in communication and/or coordination with one or more external resources 30. Users may interface with system 26 and/or external resources 30 via client computing platforms 32. The components of system 26, server 28, external resources 30, and/or client computing platforms 32 may be operatively linked via one or more electronic communication links. For example, such electronic communication links may be established, at least in part, via a network such as the Internet and/or other networks. The electronic communication links may support wired and/or wireless communication. It will be appreciated that this is not intended to be limiting, and that the scope of this disclosure includes implementations in which server 28, external resources 30, and/or client computing platforms 32 may be operatively linked via other communication media.

A given client computing platform 32 may include one or more processors configured to execute computer program modules. The computer program modules may be configured to enable one or more players associated with the given client computing platform 32 to interface with system 26 and/or external resources 30, and/or provide other functionality attributed herein to client computing platforms 32. By way of non-limiting example, the given client computing platform 32 may include one or more of a desktop computer, a laptop computer, a handheld computer, a NetBook, a Smartphone, a gaming console, and/or other computing platforms.

The external resources 30 may include sources of information, hosts and/or providers of virtual environments outside of system 26, external entities participating with system 26, and/or other resources. In some implementations, some or all of the functionality attributed herein to external resources 30 may be provided by resources included in system 26.

The server 28 may be configured to provide, or cooperate with client computing platforms 32, to provide the functionality described herein to users. This may include hosting, serving, and/or otherwise providing a services, functions, and/or information. The server 28 may include electronic storage 34, one or more processors 36, and/or other components. The server 28 may include communication lines, or ports to enable the exchange of information with a network and/or other computing platforms. Illustration of server 28 in FIG. 2 is not intended to be limiting. The server 28 may include a plurality of hardware, software, and/or firmware components operating together to provide the functionality attributed herein to server 28. For example, server 28 may be implemented by a cloud of computing platforms operating together as server 28.

Electronic storage 34 may comprise electronic storage media that electronically stores information. The electronic storage media of electronic storage 18 may include one or both of system storage that is provided integrally (i.e., substantially non-removable) with server 28 and/or removable storage that is removably connectable to server 28 via, for example, a port (e.g., a USB port, a firewire port, etc.) or a drive (e.g., a disk drive, etc.). Electronic storage 34 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 34 may include one or more virtual storage resources (e.g., cloud storage, a virtual private network, and/or other virtual storage resources). Electronic storage 34 may store software algorithms, information determined by processor 36, information received from server 28, information received from client computing platforms 34, and/or other information that enables server 28 to function properly.

Processor(s) 36 is configured to provide information processing capabilities in server 28. As such, processor 36 may include one or more of a digital processor, an analog processor, a digital circuit designed to process information, an analog circuit designed to process information, a state machine, and/or other mechanisms for electronically processing information. Although processor 36 is shown in FIG. 2 as a single entity, this is for illustrative purposes only. In some implementations, processor 36 may include a plurality of processing units. These processing units may be physically located within the same device, or processor 36 may represent processing functionality of a plurality of devices operating in coordination.

Processor 36 may be configured to execute one or more computer program modules. Processor 36 may be configured to execute these by software; hardware; firmware; some combination of software, hardware, and/or firmware; and/or other mechanisms for configuring processing capabilities on processor 36. It will be appreciated that description of the modules being executed solely on processor 38 separate from client computing platforms 32 is not intended to be limiting. For example, in some implementations, the client computing platforms 32 may be configured to provide locally at least some of the functionality attributed herein to the modules executed by processor 38.

In a first step, the voice of a user speaking a vehicle license plate number may be captured. Voice capture can be accomplished through any device or medium. In some implementations, there are substantially no known limitations as to how the end-user speaks in the license plate. For example, the voice capture may be accomplished through a microphone associated with client computing platform 32. There may be no need to use a spelling alphabet (e.g. alpha, bravo, etc.) or a particular speed or intonation in the voice. Furthermore, end-users may speak in logical abbreviations of the alphanumerical string, such as “double A” instead of “A-A” and “Twenty three” instead of “Two Three”. When alphanumerical strings are broken down in segments, separated by a space, dot, dash or other, the end-user may choose to mention so. The end-user may also be versed in using the spelling alphabet (alpha, bravo etc.) and decide to use this instead of single letters. Additionally, the end-user may or may not provide spoken information about the state in which the license plate is registered.

The audio may be recorded (e.g., locally on client computing platform 32) and/or transmitted (e.g., to server 28) without further processing. The audio may be processed, at least preliminarily, at client computing platform 32 (e.g., prior to storage and/or transmission). Such processing may result in storage and/or transmission of audio information in an alternative form to raw recorded voice data (e.g. acoustic fingerprints). For example, the audio information may be compressed, features required for further processing and/or speech recognition may be extracted.

Server 28 may then receive audio information corresponding to the alphanumeric pattern spoken by the user (and recorded by client computing platform 32). Automated speech recognition (ASR) techniques may then be applied to the audio information by server 28. This may include techniques for identifying the beginning and end of the audio recording that is attributable to the complete identifier spoken by the user. Such techniques could include: (a) asking the user to start the recording and stop the recording before and after the respective beginning and end of the spoken identifier (b) leveraging automated speech recognition technology to identify spoken words before and after the complete spoken identifier in order to identify the appropriate segment of the recording, leveraging automated speech recognition technology to identify the first and last spoken sounds associated with individual letters or numbers and thus marking the appropriate recorded segment or a wide variety of other techniques.

Applying grammar or dictation based voice recognition, server 28 may then segment the pattern represented by the audio information into letters and numbers heard (e.g., as described herein with respect to operation 14 of FIG. 1). Using the parsed characters, server 28 may generate a set of potential identifiers. This may be organized into an M×N table or matrix structure where: M represents the likely number of characters in the audio information, and N is determined by the maximum amount of possible recognitions for each character in the audio information. This matrix may be referred to herein as the “Maximum Matches” matrix. It presents all possible matching identifiers if only automated speech recognition were to be used to process the audio information. The number of possible license plates resulting from combining the M*N cells in the Maximum Matches matrix could be as high as M!*N!.

Processor 28 may assign a probability that a cell within the matrix is correct. This may be performed on a column-by-column basis. Leveraging only automated speech recognition to determine the best match may lead to poor quality results in determining the best match. Furthermore, two vehicles may have the same license plate, yet be registered in different states.

Therefore, server 28 may determine the most plausible syntax or structure of the identifier using contextual information. Such contextual information may include the location of the user, the location of the entity associated with the identifier, a description of the entity associated with the identifier (e.g., spoken by the user). For example, contextual information may include location based information (e.g., obtained though a built-in GPS unit or cell-phone triangulation) in order to identify the physical location of the user. This physical location may be used by server 28 to identify the region (e.g., country, province, state, city, zip code, and/or other regions) relevant for identifier identification. For example, if the identifier is a vehicle license plate number, assume that the relevant location is “states” (e.g. which is true for vehicle license plate numbers in the United States). Having identified the state where the end-user is currently located, server 28 may then filter and/or weight entries in the M×N Maximum Matches matrix based on that state's license plate syntax. For example, if the end-user is in Oregon, and an Oregon license plate has the format of 3 letters followed by 3 numbers (“AAA000”), then server 28 may reflect this syntax to provide greater weight and/or consideration to those combinations from the Maximum Matches matrix that conform to the syntax 3 letters followed by 3 numbers.

The server 28 may utilize precise geo-location and may exploit syntax for neighboring states as well. For example, if a license plate is input near Medford, Oreg., and there is no match for the Oregon license plate syntax, server 28 may utilize the California license plate syntax (since Medford is almost at the border with California), before evaluating Nevada, Washington, and/or Washington. The server 28 may further rank alternative syntaxes by the distance from the respective states. For example, an alternative syntax for an end-user located in Eugene, Oreg. (somewhat in the middle of the state) may be, in order of consideration, California, Nevada, Washington and Idaho.

In some implementations, the location based processing may be repeated (and filter the Maximum Matches matrix) using the license plate syntax for these neighboring states (222A-B) to arrive at a set of most likely matches. All sets of possible matches may be associated with a probability that combines (a) the probability of a correct alphanumerical character (following the initial speech recognition) and (b) the probability of a correct license plate syntax after using location based filtering. The possible vehicle license plate numbers may be ranked by this combined probability allowing the server 28 to determine, with enhanced confidence, which vehicle license plate number is represented by the audio information.

Contextual information leveraged by server 28 may include information about the user who inputs the identifier. For example, if the client computing platform 32 used to capture the audio information has the area code 415 or has provided registration information with an identifying California zip code or other California identifier (e.g., a California license plate) for themselves, the server 28 may automatically favor the California license plate syntax. Similar to using geo information-based algorithms, server 28 will subsequently explore license plates from neighboring states based on the user information.

After the processing described above, individual potential identifiers included in the set of potential identifiers carry a probability that combines (a) the probability of a correct alphanumerical character (following the initial speech recognition) and (b) the probability of a correct identifier syntax. They may be ranked by this combined probability allowing server 28 to determine, with enhanced confidence, which identifier was initially input by the end-user.

The server 28 may use contextual information that is not limited to location-based data. For example, if the identifier is a vehicle license plate number, server 28 may utilize general automotive data, such as the Vehicle in Operations Database (e.g., as one of external resources 30). If a potential license plate number matches the syntax for both Texas and Washington, D.C., server 28 may assign a higher probability to a Texas license plate number given that Texas has more registered vehicles than Washington, D.C. The server 28 may furthermore assign a probability to all outcomes depending on the ratio of vehicles registered in each state.

In some implementations, the contextual information and/or information derived therefrom, may be used to as input to the voice recognition engine to refine the processing of the automated speech recognition performed by server 28. The initial speech recognition performed by server 28 may have incorrectly segmented the number of characters in the alphanumerical string, and as such may have improperly filtered the input using contextual information (e.g., vehicle license plate number syntax information. For example, if identifier is a vehicle license plate number, and the initial recognition counts 8 characters and the input happened in California where each vehicle carries 7 digits, server 28 may run the audio information through the recognition engine again with the additional information that the audio should be analyzed as carrying 7 alphanumerical characters to obtain a better output from the automated speech recognition. The speech recognition engine of server 28 may also be guided by leveraging knowledge about the origin of the end user (e.g. a wireless phone with 415 area code number), general known information about the proportional number of vehicles associated with a specific license plate syntax, and/or other contextual information.

Accordingly, a richer set of potential identifiers, each carrying a combined probability based on speech recognition and identifier syntax may now be generated server 28. The server 28 may then force-rank the set of potential set of identifiers by likelihood. This allows server 28 to determine, with enhanced confidence, which identifier was initially spoken by the end-user. Furthermore, understanding the most plausible syntax of the identifier may allow the speech recognizer to better deal with audio information which doesn't follow an expected pattern, such as when the end-user combines letters (“Double E” instead of “E E”), numbers (“twenty three” instead of “two three”) or simply pronounces visual marks which are not alphanumerical (e.g. “dash”, “space” and even vanity signs such as a hand or heart). When the audio information is processed by the automated speech recognition for speech recognition, the automated speech recognition may be better able to evaluate the audio information to distinguish such instances since the automated speech recognition may be better able to determine precisely where there should be numbers or letters according to the identifier syntax.

It will be noted that the above description of contextual information which may be utilized by server 28 is presented by way of example and other or additional data may be utilized, such as, for example, contextual information input by the end user and/or otherwise obtained. For example, if the identifier is a vehicle license plate number, such contextual information may include one or more of the color, make, model or trim of the vehicle. By linking each potential license plate in the Maximum Matches matrix back to the Vehicle Identification Number (of VIN) (e.g., accessed via one or more of external resources 30), the system can rapidly perform VIN explosions (i.e. deciphering basic vehicle information contained in the unique 17-digit VIN). For example, the end-user may speak “E-D-F-1-2-3, Volvo XC70”. By performing a speech recognition on the identifier sequence and combining with registered vehicle data from one of external resources 30 (e.g. corresponding to a Volvo XC70) the set of likely sequences can be narrowed. However, by appending the VIN to each result and exploding the information contained within, server 28 may determine that only one of the three matches (EDF123 in this example) can be a Volvo XC70. This input of additional description information by the end-user, and/or otherwise obtained, can be combined with the above explained use of identifier syntax information.

The results obtained through processing of server 28 as discussed herein can be presented as a unique result, or potentially even as a list of most probable matches. By combining the probabilities assigned through speech recognition and the probabilities assigned through leveraging syntax and/or contextual information that can be associated with identifiers, server 28 may rank the most likely outcomes. The end user can then decide which one was correct (or if none, proceed with traditional approaches such as manual input).

The foregoing system(s) and method(s) for recognizing an audible alphanumeric pattern of an identifier may be employed in a variety of contexts. For example, implementations may be usefully employed in systems and methods which allow drivers to report the behavior, identify or network with other drivers, such as by providing a vehicle license plate number and associated behavior or a desire to contact other drivers on the road. Another example may include telephonic customer service systems that provide service, selection menus, call routing (e.g., to support personnel), purchase options, and/or other services or features to users based on user account, product, product class, service, service class, and/or other identifiers. Other contexts are contemplated.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of recognizing an audible alphanumeric pattern associated with a vehicle, the method comprising:
receiving audio information corresponding to an alphanumeric pattern spoken by a user identifying a vehicle identifier carried by a vehicle;
obtaining contextual information, wherein the contextual information comprises one or more of a context of the vehicle, a context of the user, or a description of the vehicle;
processing the received audio information to identify the vehicle identifier, wherein identification of the vehicle identifier from the received audio information is further based on the obtained contextual information.

2. The method of claim 1, wherein processing the received audio information to identify the vehicle identifier comprises:
determining a set of potential vehicle identifiers from the received audio information; and
receiving a selection of one of the potential vehicle identifiers from the user.

3. The method of claim 1, wherein the contextual information comprises contextual information input by the user and/or contextual information determined automatically.

4. The method of claim 1, wherein the contextual information comprises one or more of a location of the user, a location of the vehicle, or a state associated with the vehicle identifier.

5. The method of claim 1, wherein processing the received audio information to identify the vehicle identifier comprises:
identifying a set of potential vehicle identifiers from the received audio information; and
filtering the set of potential vehicle identifiers based on a comparison of individual potential identifiers from the set of potential vehicle identifiers with actual vehicle identifiers.

6. The method of claim 5, wherein filtering the set of potential vehicle identifiers comprises removing a given potential vehicle identifier from the set of potential vehicle identifiers responsive to the given potential vehicle identifier failing to correlate with any actual vehicle identifier in a stored set of actual vehicle identifiers.

7. The method of claim 5, wherein filtering the set of potential vehicle identifiers comprises removing a given potential vehicle identifier from the set of potential vehicle identifiers responsive to the given potential vehicle identifier correlating to an actual vehicle identifier associated with a location and/or a vehicle that contradicts the obtained contextual information.

8. The method of claim 1, wherein processing the received audio information to identify the vehicle identifier comprises:
identifying a set of potential vehicle identifiers from the received audio information; and
determining probabilities of correctness for individual ones of the potential vehicle identifiers.

9. The method of claim 1, wherein determining the probabilities of correctness for individual ones of the potential vehicle identifiers is based on the obtained contextual information.

10. A system configured to recognize spoken alphanumeric patterns, the system comprising:
one or more processors configured (i) to receive audio information, the audio information corresponding to an alphanumeric pattern spoken by a user, wherein the alphanumeric pattern is an identifier, (ii) to obtain contextual information, wherein the contextual information comprises one or more of a context of a good or service associated with the identifier, a context of the user, or a description of the good or service associated with the identifier, and (iii) to process the received audio information to identify the identifier, wherein identification of the identifier from the received audio information is further based on the obtained contextual information.

11. The system of claim 10, wherein the processor is configured to process the received audio information to identify the identifier by:
determining a set of potential identifiers from the audio information; and
receiving a selection of one of the potential identifiers from the user.

12. The system of claim 10, wherein the contextual information comprises contextual information input by the user and/or contextual information determined automatically.

13. The system of claim 10, wherein the contextual information comprises one or both of a location of the user and/or a location associated with the good or service.

14. The system of claim 1, wherein the processor is configured to process the received audio information to identify the identifier by:
identifying a set of potential identifiers from the received audio information; and
filtering the set of potential identifiers based on a comparison of individual potential identifiers from of the set of identifiers with actual identifiers.

15. The system of claim 14, wherein the processor is configured such that filtering the set of potential identifiers comprises removing a given potential identifier from the set of potential identifiers responsive to the given potential identifier failing to correlate with any actual identifier.

16. The system of claim 14, wherein filtering the set of potential identifiers comprises removing a given potential identifier from the set of potential identifiers responsive to the given potential identifier correlating to an actual identifier associated with a context that contradicts the obtained contextual information.

17. The system of claim 10, wherein the processor is configured to process the received audio information to identify the identifier by:
identifying a set of potential identifiers from the received audio information; and
determining probabilities of correctness for individual ones of the potential identifiers.

18. The system of claim 17, wherein the processor is configured such that determining the probabilities of correctness for individual ones of the potential identifiers is based on the obtained contextual information.

19. The system of claim 10, wherein the identifier is a vehicle license plate number, and wherein the good and/or service associated with the vehicle license plate number comprises a vehicle license plate.

20. The system of claim 10, wherein the identifier is a vehicle license plate number, and wherein the good and/or service associated with the vehicle license plate number comprises a vehicle.
